(19) United States
(12) Patent Application Publication
(10) Pub. No.: US 2014/0071024 A1
(43) Pub. Date: Mar. 13, 2014

(54) INTERACTIVE VIRTUAL IMAGE DISPLAY APPARATUS AND INTERACTIVE DISPLAY METHOD

(71) Applicant: WISTRON CORPORATION, New Taipei City (TW)

(72) Inventor: Chuan-Cheng Fu, New Taipei City (TW)

(73) Assignee: WISTRON CORPORATION, New Taipei City (TW)

(21) Appl. No.: 13/688,214

(22) Filed: Nov. 29, 2012

(30) Foreign Application Priority Data
Sep. 11, 2012 (TW) 101133181

(51) Int. Cl. G02B 27/01

(52) U.S. Cl. CPC G02B 27/017
USPC 345/8

(57) ABSTRACT

An interactive virtual image display apparatus configured to be worn on a head of a user includes a display unit, an image sensing module, and a control unit. The display unit forms a virtual image in front of an eye of the user. The image sensing module senses the eye. The control unit is electrically connected to the display unit and the image sensing module. The control unit receives a video signal, and drives the display unit to display the virtual image according to the video signal. The control unit has at least one operation function. The operation function controls a manner that the display unit displays the virtual image. The control unit executes the operation function corresponding to at least one action of the eye according to the at least one action of the eye sensed by the image sensing module. An interactive display method is also provided.

### CROSS-REFERENCE TO RELATED APPLICATION

This application claims the priority benefit of Taiwan application serial no. 101133181, filed on Sep. 11, 2012. The entirety of the above-mentioned patent application is hereby incorporated by reference herein and made a part of this specification.

### BACKGROUND

1. Technical Field

The invention relates to a display apparatus and a display method. Particularly, the invention relates to an interactive virtual image display apparatus and an interactive display method.

2. Related Art

Along with development of display technology and people's desire for high technology, techniques of virtual reality and augmented reality gradually become mature, and head mounted displays (HMDs) and video glasses are two types of displays implementing the above techniques.

The video glasses is also referred to as a glasses display, which is a new generation of civilian product belonging to the HMD in military use. The video glasses can produce a virtual image on a near-eye microdisplay, and the virtual image can vary within a fixed distance in front of the user's eye, which looks like a large screen television. By using proper optical calibration components, clarity and wearing comfort of the video glasses are enhanced. The video glasses of the virtual reality ensure the user to completely immerse in the played images without being interfered by any external light.

The video glasses generally use a microdisplay technique, and according to different processes of display modules, the microdisplays can be grouped into four types of a liquid crystal display (LCDs), a liquid crystal on silicon (LCOS) panel, an organic light-emitting diode display (OLED display) and a microelectromechanical system (MEMS).

The video glasses in the market are mainly used as displays of mobile video terminal products (such as mobile phones, portable media players (PMP) and digital cameras, etc.). The video glasses are generally used in collaboration with an external control box for controlling related functions thereof.

### SUMMARY

The invention is directed to an interactive virtual image display apparatus, which improves operation convenience.

The invention is directed to an interactive display method, by which operation convenience is improved.

An embodiment of the invention provides an interactive virtual image display apparatus, which is adapted to be worn on a head of a user. The interactive virtual image display apparatus includes a display unit, an image sensing module and a control unit. The display unit forms a virtual image in front of an eye of the user. The image sensing module senses the eye of the user. The control unit is electrically connected to the display unit and the image sensing module. The control unit receives a video signal, and drives the display unit to display the virtual image according to the video signal. The control unit has at least one operation function. The operation function controls a manner that the display unit displays the virtual image. The control unit executes the operation function corresponding to at least one action of the eye according to the at least one action of the eye sensed by the image sensing module.

An embodiment of the invention provides an interactive virtual image display apparatus, which is adapted to be worn on a head of a user. The interactive virtual image display apparatus includes a display unit, an image sensing module and a control unit. The display unit forms a virtual image in front of an eye of the user. The image sensing module senses a hand of the user. The control unit is electrically connected to the display unit and the image sensing module. The control unit receives a video signal, and drives the display unit to display the virtual image according to the video signal. The control unit has at least one operation function. The operation function controls a manner that the display unit displays the virtual image. The control unit executes the operation function corresponding to at least one gesture of the hand according to the at least one gesture of the hand sensed by the image sensing module.

An embodiment of the invention provides an interactive display method including following steps. A virtual image is formed in front of an eye of a user according to a video signal. It is selected to sense one of images of the eye and a hand of the user. When the eye of the user is sensed, at least one operation function corresponding to at least one action of the eye is executed according to the at least one action of the eye. When the hand of the user is sensed, at least one operation function corresponding to at least one gesture of the hand is executed according to the at least one gesture of the hand, where the at least one operation function controls a display manner of the virtual image.

According to the above descriptions, in the interactive virtual image display apparatus according to the embodiments of the invention, since the image sensing module can sense the eye or the hand of the user, the control unit can execute the corresponding operation function according to the action of the eye or the gesture of the hand. Therefore, the user can operate the interactive virtual image display apparatus through the action of the eye or the gesture of the hand, so as to improve usage convenience of the interactive virtual image display apparatus. Moreover, in the interactive display method according to the embodiment of the invention, since the action of the eye or the gesture of the hand can be selectively sensed to execute the corresponding function, convenience of interactive display is improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a light path of an interactive virtual image display apparatus according to an embodiment of the invention.

FIG. 1B is a side view of the interactive virtual image display apparatus of FIG. 1A worn on a head of a user.

FIG. 1C is a three-dimensional view of the interactive virtual image display apparatus of FIG. 1A.

FIG. 2 is a system structural diagram of the interactive virtual image display apparatus of FIG. 1A.

FIG. 3 is a schematic diagram of a menu displayed by a display unit of FIG. 1A.

FIGS. 4A-4D respectively illustrate four gestures that can be recognized by a control unit of FIG. 1A.

FIG. 5 is a flowchart illustrating an interactive display method according to an embodiment of the invention.

### DETAILED DESCRIPTION OF DISCLOSED EMBODIMENTS

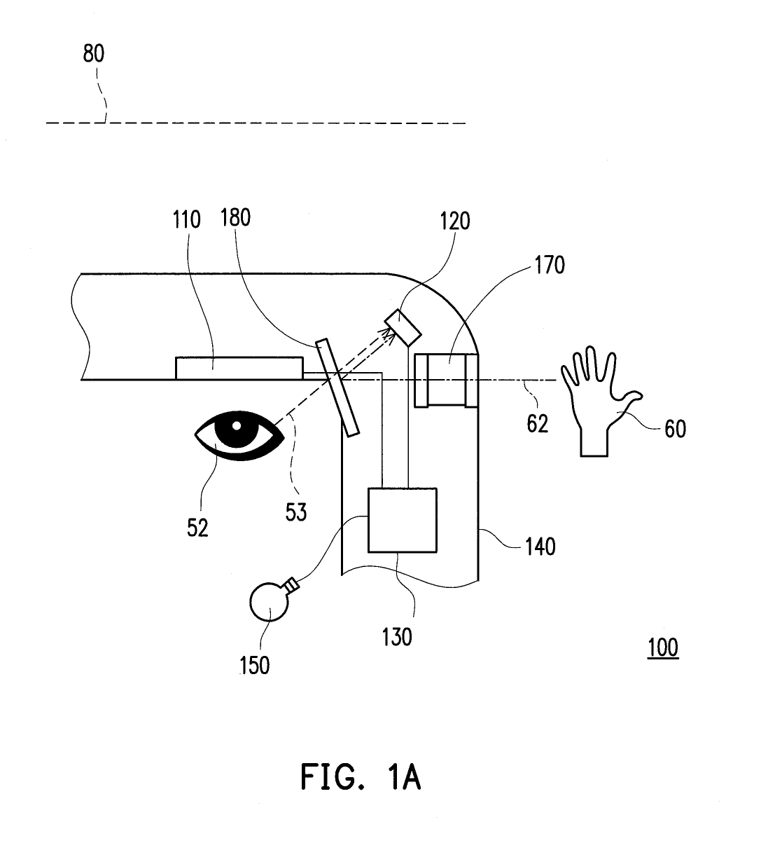

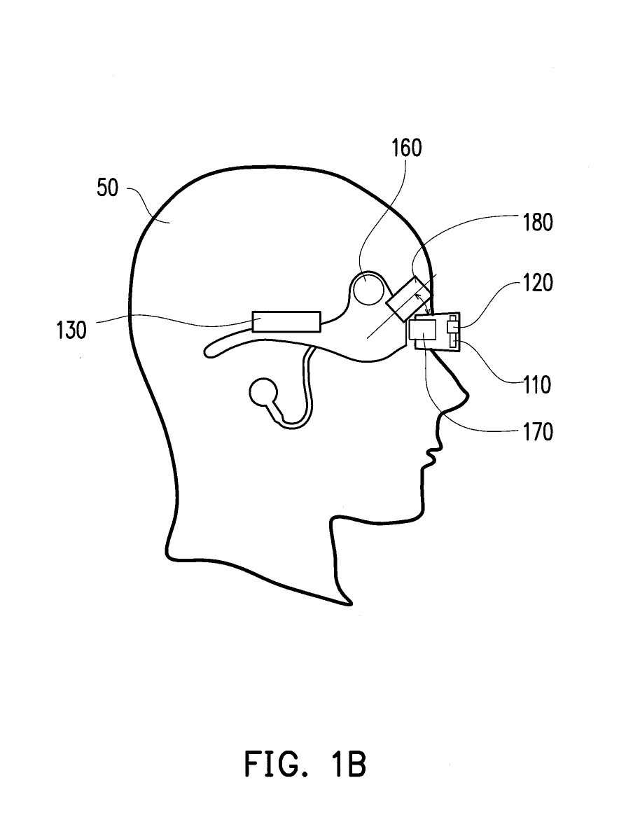

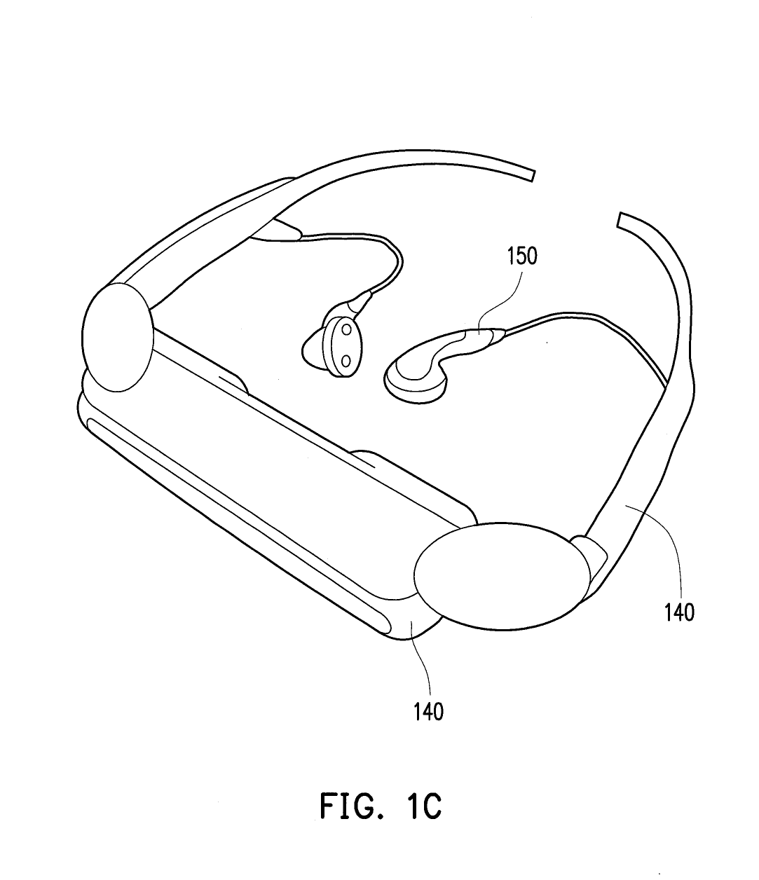

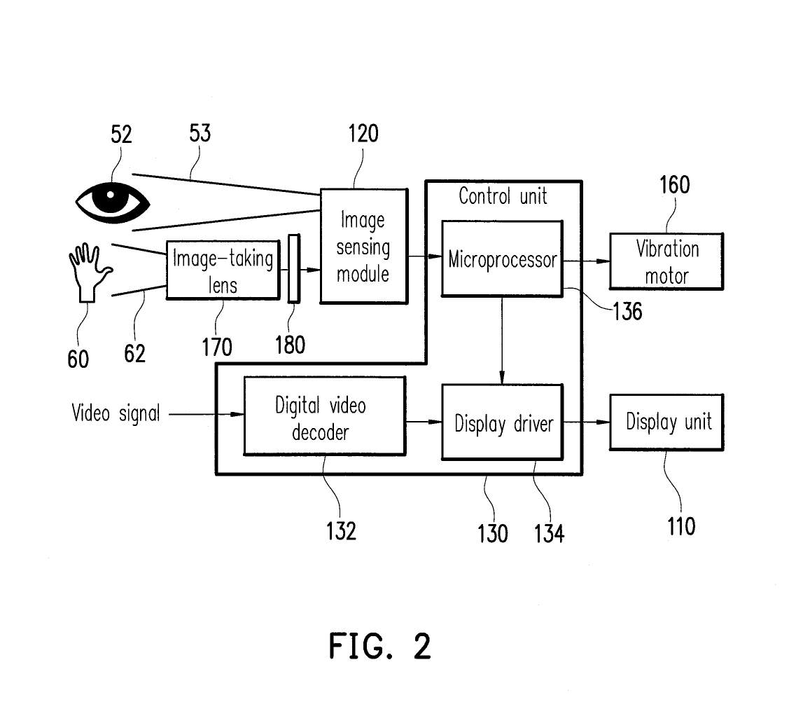

FIG. 1A is a schematic diagram of a light path of an interactive virtual image display apparatus according to an embodiment of the invention, FIG. 1B is a side view of the interactive virtual image display apparatus of FIG. 1A worn on a head of a user, FIG. 1C is a three-dimensional view of the interactive virtual image display apparatus of FIG. 1A, and FIG. 2 is a system structural diagram of the interactive virtual image display apparatus of FIG. 1A. Referring to FIG. 1A to FIG. 1C and FIG. 2, the interactive virtual image display apparatus 100 of this embodiment is adapted to be worn on a head 50 of a user. In this embodiment, the interactive virtual image display apparatus 100 is video glasses. However, in other embodiments, the interactive virtual image display apparatus 100 can also be a head mounted display (HMD). The interactive virtual image display apparatus 100 includes a display unit 110, an image sensing module 120 and a control unit 130. The display unit 110 forms a virtual image 80 in front of an eye 52 of the user. The display unit 110 may include a display panel, for example, a liquid crystal display (LCD), a liquid crystal on silicon (LCOS) panel, an organic light-emitting diode display (OLED display) and a microelectromechanical system (MEMS). Moreover, the display unit 110 may further include an optical device, and when the eye 52 of the user views the display panel through the optical device, the eye 52 of the user sees the virtual image 80 corresponding to the display panel. Alternatively, the display unit 110 can also be a retinal projector, which projects an image to be sensed by retina onto the retina, so that the user has a feeling of seeing the virtual image 80. The image sensing module 120 senses the eye 52 of the user. In this embodiment, the image sensing module 120 is, for example, a camera device.

The control unit 130 is electrically connected to the display unit 110 and the image sensing module 120. The control unit 130 receives a video signal, and drives the display unit 110 to display the virtual image 80 according to the video signal. In this embodiment, the control unit 130 includes a digital video decoder 132 and a display driver 134. The digital video decoder 132 decodes the video signal and transmits it to the display driver 134, and the display driver 134 drives the display unit 110 to display the virtual image 80 corresponding to the decoded video signal.

In this embodiment, the number of the display units 110 can be two, and the number of the image sensing modules 120 can be two. The display units 110 are respectively disposed in front of the two eyes 52 (a left eye and a right eye) of the user, and the image sensing modules 120 respectively sense the two eyes 52 of the user. Moreover, in this embodiment, the interactive virtual image display apparatus 100 further includes a glasses frame 140, and the display units 110, the image sensing modules 120 and the control unit 130 are all disposed on the glasses frame 140.

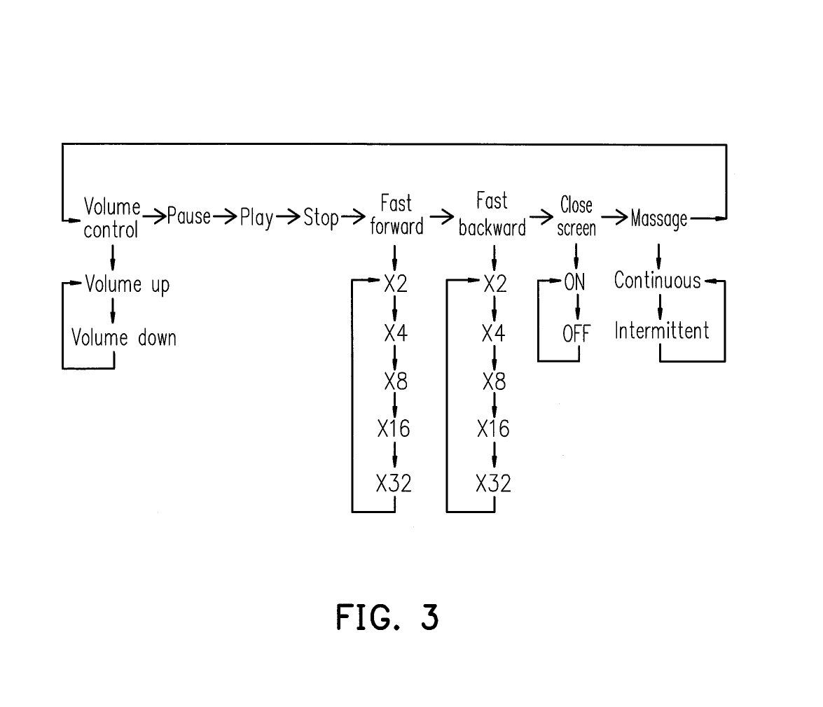

The control unit 130 has at least one operation function (for example, a plurality of operation functions in this embodiment), and the operation function controls a manner that the display unit 110 displays the virtual image 80. FIG. 3 is a schematic diagram of a menu displayed by the display unit 110 of FIG. 1A. Referring to FIG. 1A and FIG. 3, the control unit 130 further includes a microprocessor 136. The microprocessor 136 can instruct the display unit 110 to display a menu (shown in FIG. 3) through the display driver 134, and the aforementioned operation functions include an enter-menu function, a skip-to-next-item function, an enter-execution function, a stop-and-leave function or combinations thereof The control unit 130 executes the operation function corresponding to at least one action (for example, a plurality of actions in this embodiment) of the eye 52 according to the at least one action of the eye 52 sensed by the image sensing module 120. In this embodiment, the control unit 130 causes the actions of the eye 52 to respectively correspond to the operation functions.

For example, the actions of the eye 52 may include that the two eyes are closed for several seconds (for example, between 1 second and 3 seconds, for example, 2 seconds), and then the two eyes are opened, and such action may correspond to the enter-menu function. Moreover, if the operation function is not executed for a period of time (for example, 5 seconds), the control unit 130 may instruct the display unit 110 not to display the menu. The actions of the eye 52 may further include closure of a single eye, and such action may correspond to the skip-to-next-item function. Now, the menu skips to the next item every a period of time until the eye 52 is opened. The action of the eye 52 may further include that the two eyes are closed for a period of time (for example, 3 seconds), and then the two eyes are opened, and such action may correspond to the enter-execution function. Moreover, the action of the eye 52 may further include that the two eyes are closed for a period of time (for example, 1 second), and then the two eyes are opened, and such action may correspond to the stop-and-leave function.

In this embodiment, the interactive virtual image display apparatus 100 further includes a loudspeaker 150, which is electrically connected to the control unit 130. The loudspeaker 150 is, for example, an earphone. The control unit 130 receives an audio signal, and drives the loudspeaker 150 to send a sound corresponding to the audio signal according to the audio signal, and the operation function controls a manner that the loudspeaker 150 sends the sound. Moreover, in this embodiment, the interactive virtual image display apparatus 100 further includes a vibration motor 160, which is electrically connected to the control unit 130. The control unit 130 can drive the vibration motor 160 to vibrate, so as to achieve a massage effect. In this embodiment, the vibration motor 160 can be located next to a temple of the user.

In this embodiment, major items of the menu include “volume control”, “pause”, “play”, “stop”, “fast forward”, “fast backward”, “close screen” and “massage”. Moreover, minor items corresponding to the major item of “volume control” include “volume up” and “volume down”. Minor items corresponding to the major item of “fast forward” include “fast forward 2×”, “fast forward 4×”, “fast forward 8×”, “fast backward 16×” and “fast forward 32×”. Minor items corresponding to the major item of “fast backward” include “fast backward 2×”, “fast backward 4×”, “fast backward 8×”, “fast backward 16×” and “fast backward 32×”. Minor items corresponding to the major item of “close screen” include “enable the close-screen function” and “disable the close-screen function”, where when the close-screen function is activated, the display unit 110 is turned off, while the loudspeaker 150 continually plays sounds, and the user can listen to the sound with eyes closed without being interfered by the virtual image 80.

Moreover, minor items corresponding to the major item of “massage” include “continuous” and “intermittent”.

For example, when the user wants to execute the function of “fast forward 16×”, the user first closes the two eyes for 2 second and then opens the two eyes, and now the menu appears. Then, the user closes one eye, and the item skips from “volume control” to “pause”. When the user keeps closing the one eye, after a period of time (for example, 0.5 second), the item continually skips to “play”. In this way, every 0.5 second, the item skips to a next item. When the item skips to “fast forward”, the user opens the two eyes and now the item stays at “fast forward”. Then, the user closes the two eyes for 3 seconds and then opens the two eyes, and now the selection enters the minor item of “fast forward 2×”. Then, the user closes one eye, and the item sequentially skips to “fast forward 2×”, “fast forward 4×”, “fast forward 8×” and “fast backward 16×” every a period of time. When the item skips to “fast forward 16×”, the user opens the two eyes and the item stays at “fast forward 16×”. Now, the user closes the two eyes for 3 seconds and then opens the two eyes, and the content of the virtual image 80 starts to fast forward in a speed of 16× (i.e. film fast forwards). When the user wants to stop the fast forward function, the user closes the two eyes for 1 second and then opens the two eyes, and the film stops fast forwarding. Deduced by analogy, the user can execute the functions of the major items and the minor items in FIG. 3 through four actions of the eye 52.

The types of the operation functions are not limited to the above four types, and in other embodiments, other operation functions can also be used. Moreover, the actions of the eye 52 are not limited to the aforementioned four actions, and in other embodiments, the other actions of the eye 52 can also be used. The corresponding relations between the actions of the eye 52 and the operation functions are not limited to the aforementioned corresponding relations, and in other embodiment, other corresponding relations can also be used, for example, the action that the two eyes are closed for 2 seconds corresponds to the enter-execution function, and the action that the two eyes are closed for 3 seconds corresponds to the enter-menu function.

In this embodiment, the interactive virtual image display apparatus 100 further includes an image-taking lens 170, which transmits an image of a hand 60 of the user to the image sensing module 120, and the control unit 130 executes the operation function corresponding to a gesture of the hand 60 according to the gesture of the hand 60 sensed by the image sensing module 120. In this embodiment, the interactive virtual image display apparatus 100 further includes a light path switching device 180, which switches a light path of a light incident on the image sensing module 120 to a first state and a second state. When the light path is switched to the first state, a light 53 coming from the eye 52 is transmitted to the image sensing module 120, and the image sensing module 120 captures an image of the eye 52. When the light path is switched to the second state, a light 62 coming from the hand 60 is transmitted to the image sensing module 120, and the image sensing module 120 captures an image of the gesture with assistance of the image-taking lens 170.

In detail, in this embodiment, the light path switching device 180 includes a reflector or is a reflector (the reflector is, for example, a reflection mirror or a reflection prism). The reflector is adapted to move into or move away from the light path between the image sensing module 120 and the eye 52, for example, adapted to move into or move away from the light path of the light 52 coming from the eye 50. When the reflector moves into the light path between the image sensing module 120 and the eye 52 (for example, the light path switching device 180 of FIG. 1B is rotated downwards along a direction of an arrow below), the light 62 coming from the hand 60 passes through the image-taking lens 170 and is reflected by the reflector and transmitted to the image sensing module 120. When the reflector moves away from the light path between the image sensing module 120 and the eye 52 (for example, the state of the light path switching device 180 of FIG. 1B), the light 53 coming from the eye 52 is transmitted to the image sensing module 120.

In this way, as the light path switching device 180 moves into or moves away from the light path between the image sensing module 120 and the eye 52, the interactive virtual image display apparatus 100 is switched to a gesture control mode or an eye control mode.

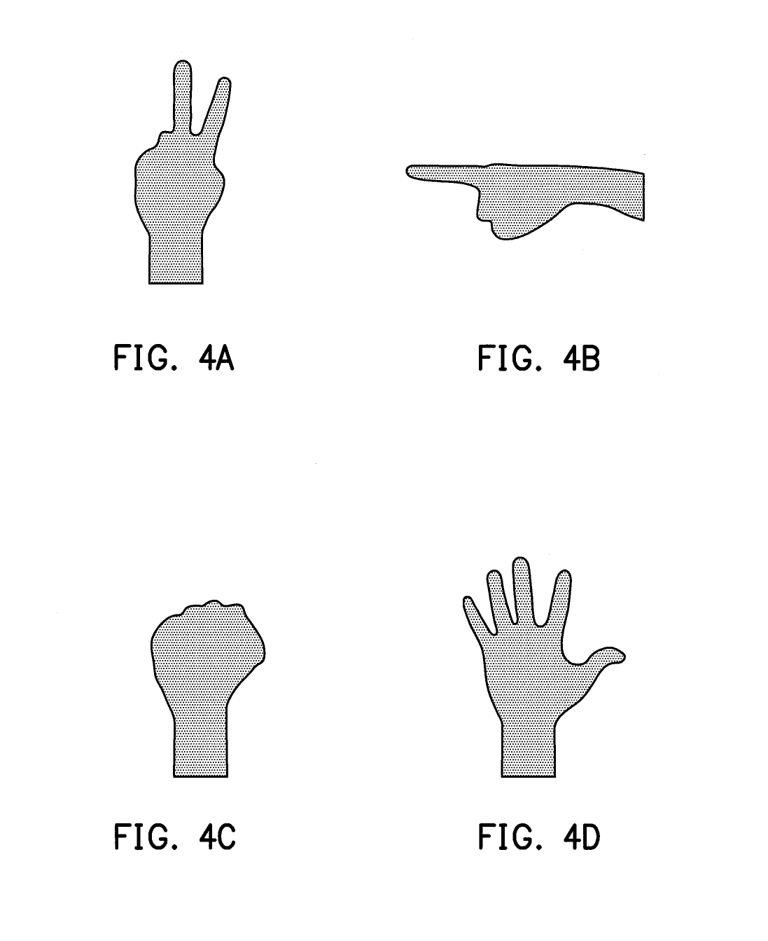

FIGS. 4A-4D respectively illustrate four gestures that can be recognized by the control unit of FIG. 1A. Referring to FIG. 4A-4D, the gesture of FIG. 4A is a gesture stretching an index finger and a middle finger, which may correspond to the enter-menu function. The gesture of FIG. 4B is a gesture stretching the index finger, where the index finger shakes up and down, which may correspond to the skip-to-next-item function. The gesture of FIG. 4C is a fist gesture, which may correspond to the enter-execution function. The gesture of FIG. 4D is a fingers open gesture, which may correspond to the stop-and-leave function.

The gestures are not limited to the aforementioned four types, and in other embodiments, the other gestures can also be used. The corresponding relations between the gestures and the operation functions are not limited to the aforementioned corresponding relations, and in other embodiment, other corresponding relations can also be used, for example, the fist gesture can correspond to the stop-and-leave function, and the fingers open gesture can correspond to the enter-menu function.

In other embodiments, the interactive virtual image display apparatus may not have the light path switching device 180, and the image sensing module 120 senses the eye 52 without sensing the hand 60, and the control unit 130 executes the operation function according to the action of the eye 52. Alternatively, in other embodiments, the image sensing module 120 of the interactive virtual image display apparatus can sense the hand 60 without sensing the eye 52, and the control unit 130 executes the operation function according to the gesture of the hand. For example, the light path switch device 180 and the image-taking lens 170 are omitted, and the image sensing module 120 faces outwards and is directly aligned to the hand 60.

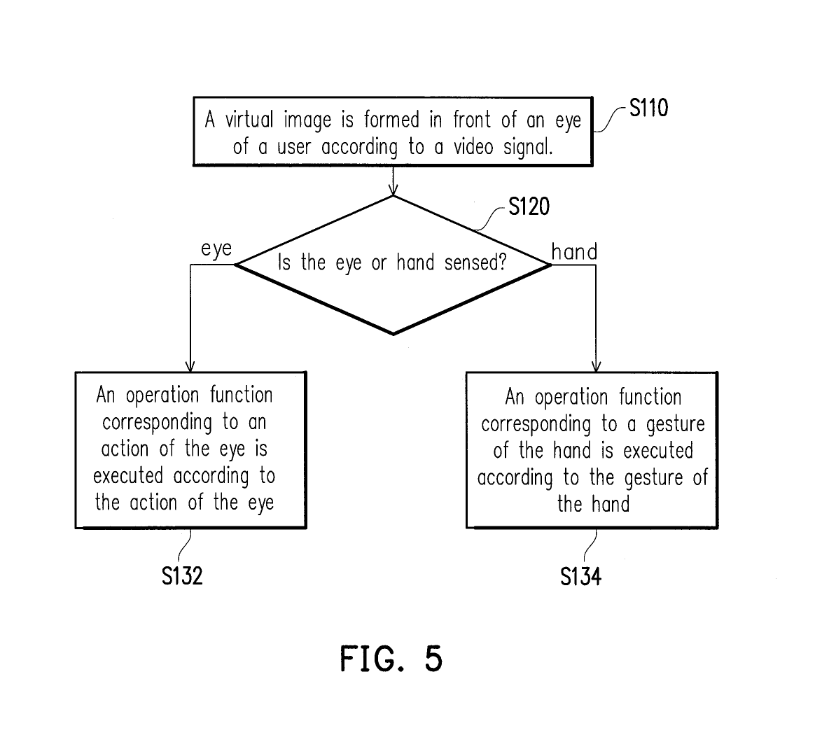

FIG. 5 is a flowchart illustrating an interactive display method according to an embodiment of the invention. Referring to FIG. 5, the interactive display method of this embodiment can be executed by the interactive virtual image display apparatus 100 of FIG. 1A, though the invention is not limited thereto. The interactive display method of this embodiment includes following steps. First, a step S110 is executed, by which the virtual image 80 is formed in front of the eye 52 of the user according to the video signal, for example, the control unit 130 processes the video signal and instructs the display unit 110 to display the virtual image 80. Then, a step S120 is executed, by which it is selected to sense one of images of the eye 52 and the hand 60 of the user. For example, when it is selected to sense the image of the hand 60, the light path switching device 180 can move into the light path between the eye 52 and the image sensing module 120. When it is selected to sense the image of the eye 52, the light path switching device 180 can move away from the light path between the eye 52 and the image sensing module 120. When the eye 52 of the user is sensed, a step S132 is executed, by which at least one operation function (a plurality of operation functions in this embodiment) corresponding to at least one action (a plurality of actions in this embodiment) of the eye 52 is executed according to the at least one action of the eye 52. When the hand 60 of the user is sensed, a step S134 is executed, by which at least one operation function (a plurality of operation functions in this embodiment) corresponding to at least one gesture (a plurality of gestures in this embodiment) of the hand 60 is executed according to the at least one gesture of the hand 60. The operation function controls a display manner of the virtual image 80, i.e. controls a display manner of the display unit 110.

In this embodiment, the interactive display method further includes sending a sound corresponding to an audio signal according to the audio signal, and the operation method controls a sound sending manner. For example, the control unit 130 can drive the loudspeaker 150 to send a sound corresponding to the audio signal, and the operation function controls a sound sending manner of the loudspeaker 150, for example, controls a volume of the loudspeaker 150.

Other details of the interactive display method of this embodiment have been described in the aforementioned embodiment of the interactive virtual image display apparatus 100, the aforementioned paragraphs can be referred for related details, which are not repeated.

In summary, in the interactive virtual image display apparatus according to the embodiments of the invention, since the image sensing module can sense the eye or the hand of the user, the control unit can execute the corresponding operation function according to the action of the eye or the gesture of the hand. Therefore, the user can operate the interactive virtual image display apparatus through the action of the eye or the gesture of the hand, so as to improve usage convenience of the interactive virtual image display apparatus. Moreover, in the interactive display method according to the embodiments of the invention, since the action of the eye or the gesture of the hand can be selectively sensed to execute the corresponding function, convenience of interactive display is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An interactive virtual image display apparatus, adapted to be worn on a head of a user, the interactive virtual image display apparatus comprising:
a display unit, forming a virtual image in front of an eye of the user;
an image sensing module, sensing the eye of the user; and
a control unit, electrically connected to the display unit and the image sensing module, wherein the control unit receives a video signal, and drives the display unit to display the virtual image according to the video signal, the control unit has at least one operation function, the operation function controls a manner that the display unit displays the virtual image, and the control unit executes the operation function corresponding to at least one action of the eye according to the at least one action of the eye sensed by the image sensing module.

2. The interactive virtual image display apparatus as claimed in claim 1, further comprising an image-taking lens, wherein the image-taking lens transmits an image of a hand of the user to the image sensing module, and the control unit executes the operation function corresponding to a gesture of the hand according to the gesture of the hand sensed by the image sensing module.

3. The interactive virtual image display apparatus as claimed in claim 2, further comprising a light path switching device, switching a light path of a light incident on the image sensing module to a first state and a second state, wherein when the light path is switched to the first state, the image sensing module captures an image of the eye, and when the light path is switched to the second state, the image sensing module captures an image of the gesture with assistance of the image-taking lens.

4. The interactive virtual image display apparatus as claimed in claim 3, wherein the light path switching device comprises a reflector adapted to move into or move away from a light path between the image sensing module and the eye, and wherein when the reflector moves into the light path between the image sensing module and the eye, a light coming from the hand passes through the image-taking lens and is reflected by the reflector and transmitted to the image sensing module, and when the reflector moves away from the light path between the image sensing module and the eye, a light coming from the eye is transmitted to the image sensing module.

5. The interactive virtual image display apparatus as claimed in claim 1, further comprising a glasses frame, wherein the display unit, the image sensing module and the control unit are all disposed on the glasses frame.

6. The interactive virtual image display apparatus as claimed in claim 1, further comprising a loudspeaker, electrically connected to the control unit, wherein the control unit receives an audio signal, and drives the loudspeaker to send a sound corresponding to the audio signal according to the audio signal, and the operation function controls a manner that the loudspeaker sends the sound.

7. The interactive virtual image display apparatus as claimed in claim 1, wherein the at least one operation function is a plurality of operation functions, the at least one action of the eye is a plurality of actions, the control unit respectively causes the actions of the eye to respectively correspond to the operation functions, and the operation functions comprise an enter-menu function, a skip-to-next-item function, an enter-execution function, a stop-and-leave function or combinations thereof.

8. An interactive virtual image display apparatus, adapted to be worn on a head of a user, the interactive virtual image display apparatus comprising:
a display unit, forming a virtual image in front of an eye of the user;
an image sensing module, sensing a hand of the user; and
a control unit, electrically connected to the display unit and the image sensing module, the control unit receives a video signal, and drives the display unit to display the virtual image according to the video signal, the control unit has at least one operation function, the operation function controls a manner that the display unit displays the virtual image, and the control unit executes the operation function corresponding to at least one gesture of the hand according to the at least one gesture of the hand sensed by the image sensing module.

9. The interactive virtual image display apparatus as claimed in claim 8, further comprising an image-taking lens, wherein the image-taking lens transmits an image of a hand of the user to the image sensing module.

10. The interactive virtual image display apparatus as claimed in claim 8, further comprising a glasses frame, wherein the display unit, the image sensing module and the control unit are all disposed on the glasses frame.

11. The interactive virtual image display apparatus as claimed in claim 8, further comprising a loudspeaker, electrically connected to the control unit, wherein the control unit receives an audio signal, and drives the loudspeaker to send a sound corresponding to the audio signal according to the audio signal, and the operation function controls a manner that the loudspeaker sends the sound.

12. The interactive virtual image display apparatus as claimed in claim 8, wherein the at least one operation function is a plurality of operation functions, the at least one gesture of a hand is a plurality of gestures, the control unit causes the gestures to respectively correspond to the operation functions, and the operation functions comprise an enter-menu function, a skip-to-next-item function, an enter-execution function, a stop-and-leave function or combinations thereof.

13. An interactive display method, comprising:
forming a virtual image in front of an eye of a user according to a video signal;
selecting to sense one of images of the eye and a hand of the user;
executing at least one operation function corresponding to at least one action of the eye according to the at least one action of the eye when the eye of the user is sensed; and
executing at least one operation function corresponding to at least one gesture of the hand according to the at least one gesture of the hand when the hand of the user is sensed,
wherein the at least one operation function controls a display manner of the virtual image.

14. The interactive display method as claimed in claim 13, further comprising sending a sound corresponding to an audio signal according to the audio signal, wherein the at least one operation function controls a manner of sensing the sound.

15. The interactive display method as claimed in claim 13, wherein the at least one operation function is a plurality of operation functions, the at least one action of the eye is a plurality of actions, the at least one gesture of the hand is a plurality of gestures, and the operation functions comprise an enter-menu function, a skip-to-next-item function, an enter-execution function, a stop-and-leave function or combinations thereof.
